(19) United States
(12) Patent Application Publication
(10) Pub. No.: US 2025/0317322 A1
(43) Pub. Date: Oct. 9, 2025

(54) CONTROLLER AREA NETWORK WIRING FAULT DETECTION

(71) Applicant: Ford Global Technologies, LLC., Dearborn, MI (US)

(72) Inventors: Ajeya Gupta, Canton, MI (US); Amrit Gopal, Pittsburgh, PA (US); Douglas A. Oliver, Redford, MI (US); Yu-Ting Wu, Dearborn, MI (US)

(21) Appl. No.: 18/627,929

(22) Filed: Apr. 5, 2024

(51) Int. Cl. H04L 12/40

(52) U.S. Cl. CPC H04L 12/40169; H04L 12/40013; H04L 2012/40215; H04L 2012/40273

(57) ABSTRACT

A microprocessor is connected with a controller area network (CAN) transceiver via transmission and receiver lines. It initiates a pulse on the transmission line during an idle time of twisted wires associated with the CAN transceiver such that signals are transmitted on the twisted wires. A comparator has an input from the receiver line and an output to the microprocessor.

### TECHNICAL FIELD

This disclosure relates to communication among vehicle modules.

### BACKGROUND

Controller Area Network (CAN) is a vehicle bus standard designed to allow microcontrollers and devices within a vehicle (e.g., electronic control units (ECUs)) to communicate with each other without needing a host computer. It was developed to facilitate complex communication between various vehicle components while ensuring reliability, a high degree of real-time capability, and resistance to interference.

### SUMMARY

An automotive communication system includes a CAN transceiver associated with twisted wires, a microprocessor connected with the CAN transceiver via transmission and receiver lines, and programmed to initiate a pulse on the transmission line during an idle time of the twisted wires such that signals are transmitted on the twisted wires, and a comparator having an input from the receiver line and an output to the microprocessor.

A method includes, during an idle time of twisted wires associated with a CAN transceiver, initiating a pulse on a transmission line connecting a microprocessor and the CAN transceiver and at a same time, initiating a signal to a comparator, and generating a message regarding a state of the twisted wires based on output of the comparator resulting from the pulse.

An automotive communication control system includes a microprocessor that initiates a pulse on a transmission line such that signals are transmitted on twisted wires of a controller area network and that generates a message regarding a state of the twisted wires based on data associated with a reflection of the pulse from the twisted wires.

### BRIEF DESCRIPTION OF THE DRAWINGS

FIG. 1 is a schematic diagram of a vehicle and portions of a conventional CAN.

FIG. 2 is a schematic diagram of a vehicle and portions of a CAN.

FIG. 3 are signal traces for logic associated with a CAN.

FIG. 4 is a schematic diagram of a vehicle and portions of a CAN.

FIG. 5 is a flow chart of an algorithm for detecting faults on a CAN.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A CAN typically includes multiple ECUs connected via a two-wire bus, which acts as a shared communication medium for all network participants. The two wires are referred to as CAN High and CAN Low, which carry differential signals to minimize electromagnetic interference. This topology allows for message broadcasting, where a single message from one ECU can be received by all other ECUs on the network.

Unlike networks that use fixed addresses for devices such as in a traditional computer network, CAN operates on a message-based protocol. Each message has a unique identifier (ID) that determines its priority on the network. Lower ID numbers have higher priority, ensuring critical messages are transmitted first.

CAN uses a non-destructive arbitration method to manage access to the bus. If two or more ECUs attempt to send messages simultaneously, the ECU with the message of the highest priority (lowest ID number) wins the arbitration and can continue transmitting. This is achieved without corruption or delay of the high-priority message, thanks to the differential signaling and the wired-AND logic of the bus.

CAN protocol defines different frame types, including data frames (for message transmission), remote frames (for requesting data), error frames (for error detection and signaling), and overload frames (for managing bus traffic). Data frames carry the payload, which is the actual data intended for transmission.

CANs are designed with error handling mechanisms to ensure reliable communication. These include error detection techniques such as checksums, frame checks, and acknowledgment checks; automatic retransmission of corrupted messages; and fault confinement mechanisms to identify and isolate faulty nodes, preventing them from compromising the network's integrity.

The speed of a CAN may vary, typically up to 1 Mbps for shorter distances. The maximum network length and bit rate are inversely related due to signal propagation times and the need to maintain synchronization across all nodes.

In automotive systems, CAN is used for a wide range of applications, from simple network communication between body control modules (like window controls) to more complex systems such as engine control units, transmission control modules, and advanced driver assistance systems.

Performance of a CAN is highly dependent on the endpoint termination circuitry and on the wiring harness in-between. The termination circuit is fixed in the ECU design. The wiring harness can have a myriad of configurations and is susceptible to mis-build or other issues leading to poor signal quality between endpoints. Poor signal quality may cause message frame loss. Methods exist to detect loss of communication. Diagnostic codes are set indicating this loss (using diagnostic tools). These methods check the CAN error counter, and the state of the transceiver during vehicle operation (e.g., bus off, error passive state, etc.). These methods, however, do not consider the electrical behavior of the CAN signal and do not identify faults like open/short wires. It may be helpful to analyze CAN behavior real time and determine the quality of the signal on the CAN bus to overcome the shortcomings mentioned previously.

The proposed strategies may help identify the root cause associated with CAN issues before the CAN is unable to communicate. These systems may be implemented in the hardware design with minimal additions of passive components. Certain of the proposed strategies use one integrated circuit on the board.

Some existing strategies for CAN monitoring to diagnose signal quality issues require two additional CAN transceivers, along with a special integrated circuit. Others require use of a multimeter to investigate the wiring continuity between the modules.

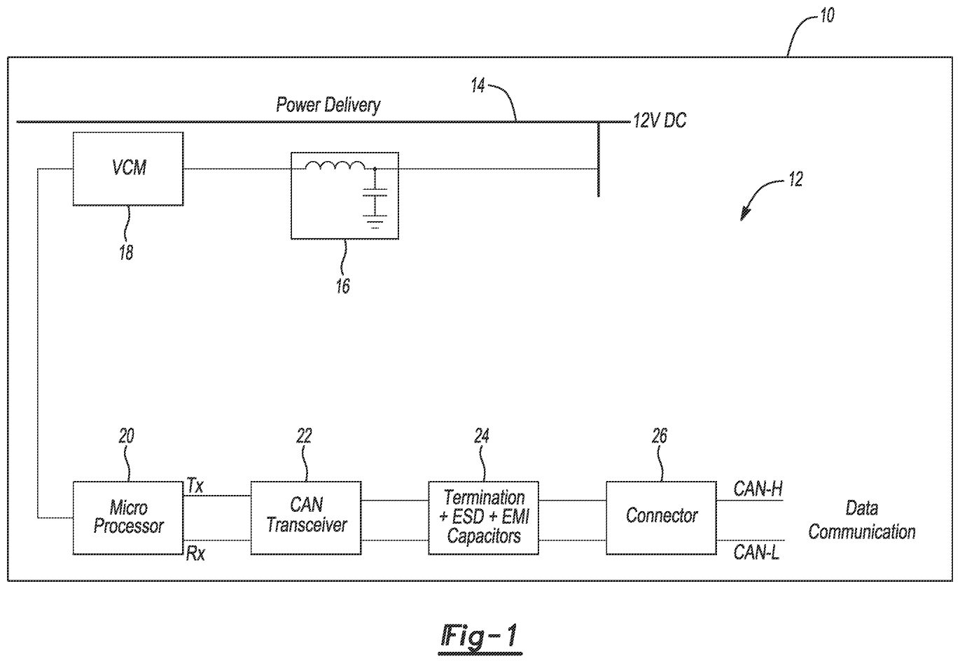

Referring to FIG. 1, a vehicle 10 includes a conventional CAN system 12. The CAN system 12 includes a power delivery line 14 (e.g., 12V DC line), passive components 16 (e.g., an inductor and capacitor), voltage control module 18, microprocessor 20, CAN transceiver 22, termination circuitry, electrostatic discharge components, and electromagnetic interference capacitors 24, and connector 26.

The passive components 16 are connected between the power delivery line 14 and voltage control module 18. The voltage control module 18 is connected with the microprocessor 20 via a voltage input/output line. The microprocessor 20 is connected with the CAN transceiver 22 via transmission (Tx) and receiver (Rx) lines. The termination circuitry, electrostatic discharge components, and electromagnetic interference capacitors 24 are connected between the CAN transceiver 22 and connector 26. Outputs of the connector 26 include CAN High (CAN-H) and CAN Low (CAN-L) lines.

The proposed strategies leverage pulse reflection theory, often associated with Time Domain Reflectometry (TDR). Pulse reflection theory can be relevant to the diagnosis and localization of faults in cables and wired networks. This theory underpins techniques used to identify and locate discontinuities, such as breaks, shorts, or impedance mismatches, in electrical transmission lines.

A pulse or signal is sent down a transmission line. When this pulse encounters any discontinuity in the line-such as a change in impedance, a break, or a short—it partially or completely reflects back toward the source. By analyzing these reflections, one can infer properties about the transmission line or locate faults.

Generally speaking, a test pulse is generated and sent along the transmission line from one end. This line could be anything from a copper wire to a fiber optic cable, depending on the application. When the pulse reaches a discontinuity (e.g., an impedance mismatch, an open circuit, or a short circuit), a portion of the pulse's energy is reflected back toward the source. The nature of the discontinuity affects the magnitude and phase of the reflected pulse. For instance, an open circuit should reflect a pulse with the same polarity, while a short circuit should reflect a pulse with inverted polarity. A matched impedance condition should not yield a reflection.

The time it takes for the reflection to return can be measured. Since the speed at which the pulse travels along the medium is known (or can be estimated), the distance to the discontinuity can be calculated based on the time delay of the reflected pulse. The amplitude and shape of the reflection provide information about the nature of the discontinuity.

Pulse reflection techniques are widely used to locate faults in cables, such as breaks or degradation in insulation, by identifying the precise location of a discontinuity. In communication networks, including data centers and telecommunication networks, TDR can help maintain the integrity of wiring by identifying and localizing issues without the need for extensive physical inspection. The technique can also measure the characteristic impedance of transmission lines and detect any deviations that might affect signal integrity.

One of the advantages of pulse reflection theory-based techniques is their non-destructive nature, allowing for real-time diagnostics without affecting the system. Advanced TDR equipment can locate faults with high precision, which is helpful for complex or sensitive communication systems. A limitation, however, can be the complexity of analyzing reflected signals, especially in environments with multiple discontinuities or complex impedance profiles.

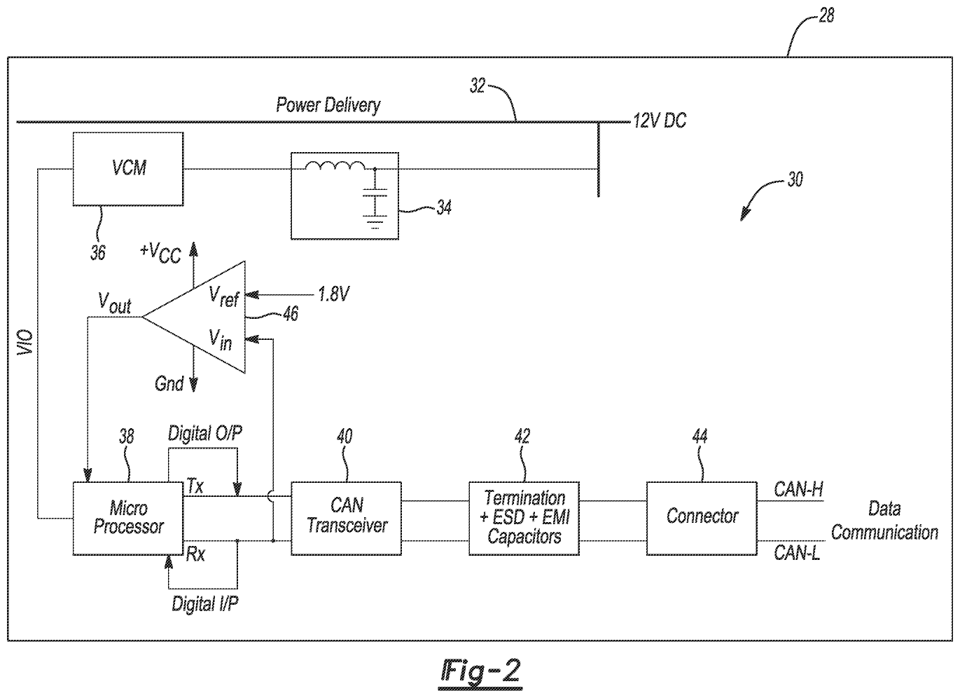

Given this information, the proposed strategies introduce hardware to facilitate use of pulse reflection theory within a CAN environment. Referring to FIG. 2, a vehicle 28 includes a CAN system 30. The CAN system 30 includes a power delivery line 32 (e.g., 12V DC line), passive components 34 (e.g., an inductor and capacitor), voltage control module 36, microprocessor 38, CAN transceiver 40, termination circuitry, electrostatic discharge components, and electromagnetic interference capacitors 42, and connector 44. These components are connected as described above.

The vehicle 28 also includes a comparator operational amplifier 46, which has a voltage input Vin from the Rx line, a reference voltage input Vref (1.8V in this example), and a voltage output Vout fed to the microprocess 38. The microprocessor 38 includes a digital output line (Digital O/P) fed to the Tx line and a digital input line (Digital I/P) received from the Rx line.

The microprocessor 38 is programmed to, in this example, send a one-bit pulse (e.g., 2 us long) directly to the Tx line, and to read responses from the Rx line. The comparator operational amplifier 46 compares the voltage input from the Rx line to the fixed reference voltage.

Between two CAN frames, there is an idle time when the bus is pulled down to a recessive state (low power state). This time can be used to inject the 2 us long pulse (equivalent to a 500 kbps CAN bit). Once the pulse is injected on the Tx line, the CAN transceiver 40 will transmit CAN High and CAN Low signals on the twisted wires. Depending on bus condition, a certain behavior is expected when the signal is read on the Rx line by the operational amplifier comparator 46. This feedback to the voltage input of the comparator operational amplifier 46 is compared to the reference voltage, and its output is read by the microprocessor 38. If the voltage input is greater than the reference voltage, the voltage output equals Vcc: The bus is normal or open. If the voltage input is less than the reference voltage, the voltage output equals ground: The bus is shorted.

A reference voltage of 1.8V was chosen for this example because the open/normal/short condition voltages are either below or above it. Additionally, 1.8V is easily accessible from other CAN connections, and hence a separate DC/DC converter is not required.

The comparator operational amplifier 46 will always output either Vcc or ground based on the inputs. The microprocessor 38 may thus interpret results when there are no faults on the bus. Approaches to address this issue include powering on the comparator operational amplifier 46 only during certain times when the true condition of the bus is desired and programming the microprocessor 38 regarding when to interpret the results.

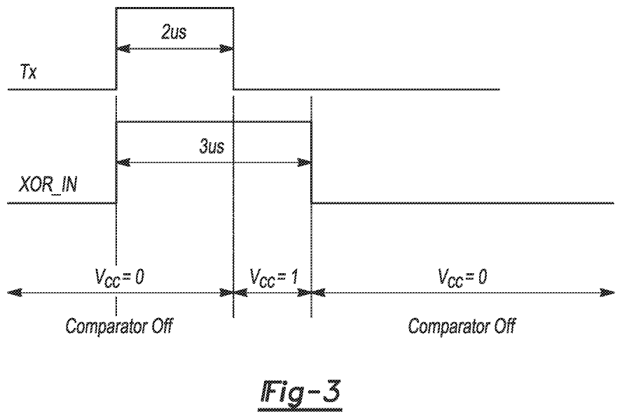

Regarding the first approach, the comparator operational amplifier 46 will be operational only when Vcc is high—equal to the voltage required to turn on this integrated circuit. The Vcc can be controlled via an XOR gate which has two inputs: XOR_IN and the Tx line. XOR_IN is a pulse that starts the same time when Tx is sent and continues for a 3 us long duration in this example. Tx is a pulse with ‘0,’ followed by a 2 us ‘1.’ The comparator stages will be on when Vcc is 1, and this happens only when Tx is ‘0’ (powered on). The comparator stages will be off when Vcc is 0, and this happens when Tx is ‘1.’ This circuit to control the comparator stages may be helpful because the comparing action on the reflected pulse should only be performed after the pulse is sent on the bus. Referring to FIG. 3, the Tx and XOR_IN signals and the corresponding comparator stage state is shown.

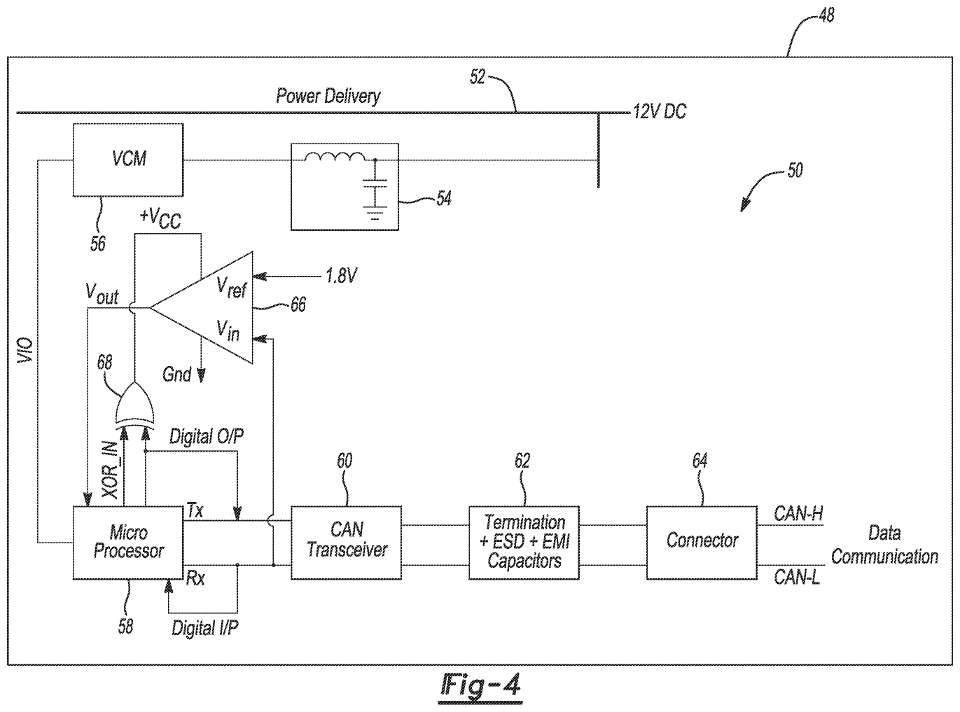

Referring to FIG. 4, a vehicle 48 includes a CAN system 50. The CAN system 50 includes a power delivery line 52 (e.g., 12V DC line), passive components 54 (e.g., an inductor and capacitor), voltage control module 56, microprocessor 58, CAN transceiver 60, termination circuitry, electrostatic discharge components, and electromagnetic interference capacitors 62, connector 64, and comparator operational amplifier 66. These components are connected and generally operate as described with reference to FIG. 2.

The vehicle 48 further includes an XOR gate 68 with an output connected to Vcc, and inputs from the XOR_IN and digital output for the Tx line. This arrangement implements the first approach described above.

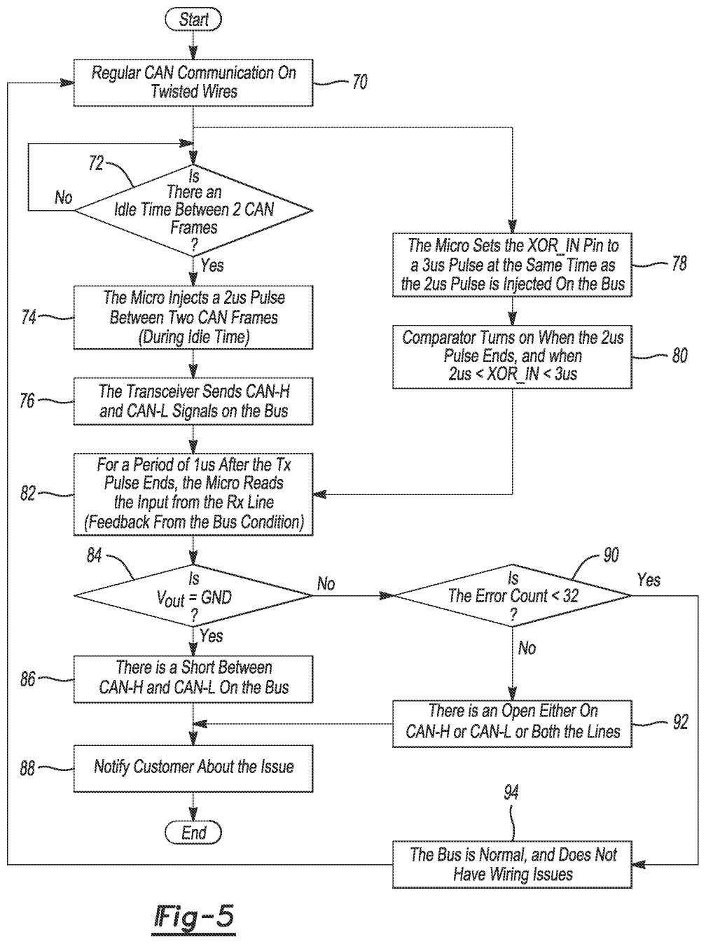

Referring to FIG. 5, regular CAN communication on twisted wires occurs at operation 70. At operation 72, it is determined using known techniques whether there is an idle time between two CAN frames. If no, the algorithm returns to operation 72. If yes, the microprocessor injects a 2 us pulse during the idle time at operation 74. At operation 76, the transceiver sends the CAN High and CAN Low signals on the bus.

At operation 78, the microprocessor sets the XOR_IN pin to a 3 us pulse at the same time the 2 us pulse is injected on the bus at operation 74. At operation 80, the comparator turns on when the 2 us pulse ends, and when 2 us is less than XOR_IN, and XOR_IN is less than 3 us.

At operation 82, for a period of 1 us after the Tx pulse ends, the microprocessor starts to read the input from the Rx line. At operation 84, it is determined whether Vout is equal to ground. If yes, there is a short between the twisted wires on the bus at operation 86. At operation 88, a message is generated regarding the issue, which may be forwarded to the manufacturer and/or owner of the vehicle.

Returning to operation 84, if no, it is determined using known techniques whether the error count is less than, for example, thirty-two at operation 90. If no, there is an open on either (or both) of the twisted wires at operation 92. The algorithm then proceeds to operation 88.

Returning to operation 90, if yes, the bus is normal and does not have any issues at operation 94. The algorithm then proceeds to operation 70.

Regarding the second approach, the microprocessor is programmed to decide when to use the result as true output. In one example, a timer is set when a 2 us pulse for example, is injected on the bus. The results are then interpreted when the timer reads 2 us, for a total of lus (from t equal to 2 us to t equal to 3 us). Once the timer stops, the microprocessor is informed that the results are not required to be interpretated.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Other architectures, for example, are contemplated, and the time duration of signals may be different than those of the examples above based on design requirements.

The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An automotive communication system comprising:
a controller area network (CAN) transceiver associated with twisted wires;
a microprocessor connected with the CAN transceiver via transmission and receiver lines, and programmed to initiate a pulse on the transmission line during an idle time of the twisted wires such that signals are transmitted on the twisted wires; and
a comparator having an input from the receiver line and an output to the microprocessor.

2. The automotive communication system of claim 1, wherein the microprocessor is further programmed to identify a state of the twisted wires based on a signal on the output.

3. The automotive communication system of claim 2, wherein the microprocessor is further programmed to generate a message regarding the state.

4. The automotive communication system of claim 2, wherein the signal results from a reflection of the pulse.

5. The automotive communication system of claim 2, wherein the microprocessor is further programmed to initiate a timer when the pulse is initiated on the transmission line such that the microprocessor identifies the state only during a predefined period after the pulse.

6. The automotive communication system of claim 1 further comprising a logic gate having an input from the microprocessor and an output to a power supply input of the comparator.

7. The automotive communication system of claim 6, wherein the logic gate is an XOR gate.

8. The automotive communication system of claim 6, wherein the microprocessor is further programmed to initiate a signal to the logic gate when the pulse is initiated on the transmission line such that the comparator is ON for a predefined period after the pulse.

9. The automotive communication system of claim 8, wherein a duration of the signal to the logic gate is longer than a duration of the pulse.

10. The automotive communication system of claim 1, wherein the pulse is a one-bit pulse.

11. A method comprising:
during an idle time of twisted wires associated with a controller area network (CAN) transceiver, initiating a pulse on a transmission line connecting a microprocessor and the CAN transceiver and at a same time, initiating a signal to a comparator; and
generating a message regarding a state of the twisted wires based on output of the comparator resulting from the pulse.

12. The method of claim 11, wherein the pulse is a one-bit pulse.

13. The method of claim 12, wherein a duration of the signal is longer than a duration of the pulse.

14. An automotive communication control system comprising:
a microprocessor programmed to initiate a pulse on a transmission line such that signals are transmitted on twisted wires of a controller area network and to generate a message regarding a state of the twisted wires based on data associated with a reflection of the pulse from the twisted wires.

15. The automotive communication control system of claim 14, wherein the microprocessor is further programmed to identify the state as open circuit responsive to the data indicating the reflection has a same polarity as the pulse.

16. The automotive communication control system of claim 14, wherein the microprocessor is further programmed to identify the state as short circuit responsive to the data indicating the reflection has an inverted polarity relative to the pulse.

17. The automotive communication control system of claim 14, wherein the microprocessor is further programmed to start a timer when the pulse is initiated on the transmission line.

18. The automotive communication control system of claim 14, wherein the microprocessor is further programmed to initiate a signal to a logic gate when the pulse is initiated on the transmission line.

19. The automotive communication control system of claim 18, wherein the pulse is a one-bit pulse.

20. The automotive communication control system of claim 19, wherein a duration of the signal to the logic gate is longer than a duration of the pulse.
